(19) United States
(12) Patent Application Publication
(10) Pub. No.: US 2003/0075008 A1
(43) Pub. Date: Apr. 24, 2003

(54) Arched bicycle crank arm

(76) Inventor: Ichiro Suga, Osaka (JP)

Correspondence Address: Allen W. Groenke, Fredrikson & Byron, P.A., 4000 Pillsbury Center, 200 South Sixth Street, Minneapolis, MN, 55402, US

(21) Appl. No.: 10/292,995

(22) Filed: Nov. 13, 2002

Related U.S. Application Data
(63) Continuation-in-part of application No. 09/667,820, filed on Sep. 22, 2000.
(60) Provisional application No. 60/168,650, filed on Dec. 3, 1999.

(51) Int. Cl. G05G 1/14

(52) U.S. Cl. 74/594.1

(57) ABSTRACT

An arched bicycle crank arm. A free end of the arched bicycle crank arm is attached to a pedal and a fulcrum end of the arched bicycle crank arm is attached to a bicycle sprocket hub. The bicycle sprocket hub turns a rear sprocket wheel through an endless drive chain via a front sprocket.

### RELATED APPLICATIONS

This application is a continuation-in-part (CIP) of U.S. patent application Ser. No. 09/667,820 by Suga, the entire disclosure of which is hereby incorporated by reference.

### FIELD OF THE INVENTION

The present invention relates generally to crank arms, for example, crank arms used on bicycles.

### BACKGROUND OF THE INVENTION

Conventional straight crank arms transfer power to the fulcrum in proportion to the length, weight and strength of the arm. Accordingly, the conventional straight crank arms transfer more power to the central hub, or fulcrum provided that the conventional straight arms need a longer length, additional weight and great strength as an essential condition of a primitive straight arm.

### SUMMARY OF THE INVENTION

Conventional straight crank levers transfer power to the fulcrum in proportion to the length, weight and strength of the arm. The arched crank arm is designed to transfer more power to the central hub, or fulcrum, than a straight arm of the same resting length. Also, less energy is required to move the free end of the curved arm in order to achieve the same torque on the central hub as a straight lever. FIG. 1 shows an arched bicycle crank arm. In FIG. 2, the arched bicycle crank arm is shown attached to a pedal and a bicycle sprocket hub which turns a rear sprocket wheel through an endless drive chain via a front sprocket. In FIG. 3, bicycle includes the arched bicycle crank arm.

The arched bicycle crank arm is designed to transfer maximum power to the hub of the bicycle's rear sprocket wheel. The wider end in FIG. 6 is herein described as the “fulcrum end”, while the narrower end in FIG. 6 is described as the “free end”.

As shown in FIG. 7, the arched bicycle crank arm is designed to generate the strongest centripetal force when rotated in one direction only. The arm is positioned with the concave arch on the bottom and convex arch on top. When the fulcrum point is centered and the free end of the arm is to the right, maximum power is generated when the lever is rotated clock wise. When the free end of the arm is to the left, maximum power is generated when the lever is rotated counter-clockwise, and a conventional straight crank arm's circle is as same as a free end's circle of the arched bicycle crank arm with the strongest centripetal force.

Conventional straight crank levers transfer power to the fulcrum in proportion to the length, weight and strength of the arm. The arched crank arm is designed to transfer more power to the central hub, or fulcrum, than a straight arm of the same resting length (e.g., the length between the fulcrum end and the free end in FIG. 4, FIG. 5 and FIG. 6 ). Also, less energy is required to move the free end of the curved arm in order to achieve the same torque on the central hub as a straight lever.

Applicant has found that bicycle cranks in accordance with the present invention provide for more pleasant pedaling. Applicant has fabricated a first crank arm and a second crank arm in accordance with the present invention and installed these arms on a bicycle. Applicant rode this bicycle on a daily basis over a period of one month including going up hills. Additionally, applicant invited two other persons to ride this bicycle. These other persons reported that the bicycle provided a more leisurely and pleasant feeling to pedaling instead a feeling of hard work. Crank arms in accordance with the present invention provide a feeling as though the bike is working for the rider. Bicycle cranks in accordance with the present invention provide a better interface during the upstroke portion of pedaling. Without wishing to be bound to any particular theory, it appears that crank arms in accordance with some embodiments of the present invention provide a feeling that the work is being more evenly divided between the rider's two legs.

### DESCRIPTION OF THE DRAWINGS

FIG. 1 shows side and top elevation details of the arched bicycle crank arm.

FIG. 2 is a view of the arched bicycle crank arm attached to a bicycle sprocket.

FIG. 3 is a schematic side view of the arched bicycle crank arm installed on a bicycle.

FIG. 4 through FIG. 6 illustrate arched bicycle crank arm evolution of design by way of a simple diagram showing side elevations of three levers.

FIG. 4 is a plan view of a straight crank arm.

FIG. 5 is a straight leverage crank arm that it is my invention to evolve the straight crank arm to the arched bicycle crank arm.

FIG. 6 is a plan view of an arched crank arm: increases leverage and exerts great centripetal force by the arched arm.

FIG. 7 diagrams the rotation and the torque of the arched bicycle crank arm.

### DETAILED DESCRIPTION

The following detailed description should be read with reference to the drawings, in which like elements in different drawings are numbered identically. The drawings, which are not necessarily to scale, depict selected embodiments and are not intended to limit the scope of the invention. Accordingly, it is to be understood that the invention is not limited in its application to the details of construction and the arrangements of components set forth in the following description or illustrated in the drawings.

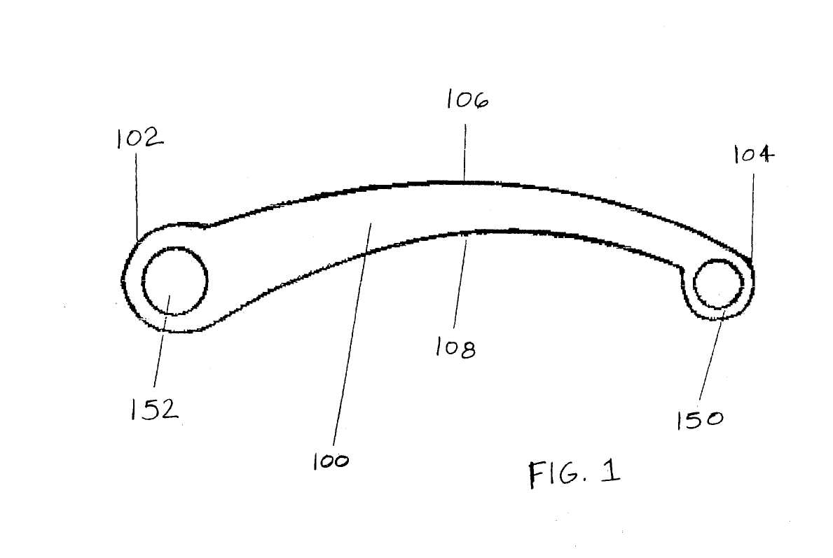

FIG. 1 is a plan view of a crank arm 100 in accordance with an exemplary embodiment of the present invention. In FIG. 1 it may be appreciated that crank arm 100 has a fulcrum end 102 and a free end 104. In the embodiment of FIG. 1, crank arm 100 has a generally curved resting shape defining a convex arch 106 and a concave arch 108. A pedal assembly may threadingly engage a hole defined by crank arm 100 at 150. A fulcrum point 152 is shown centered in a second hole defined by crank arm 100.

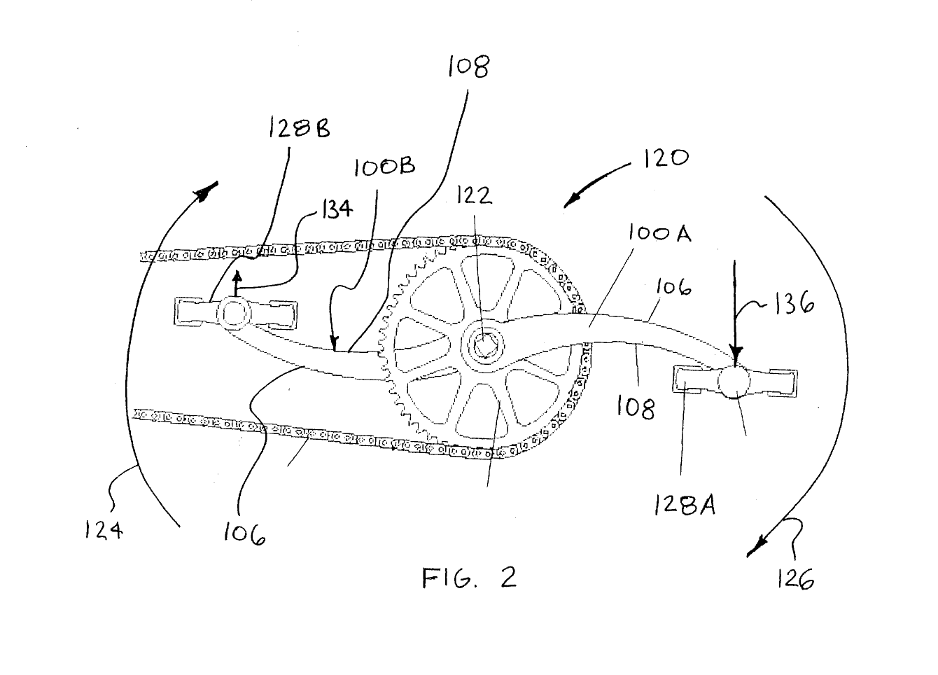

FIG. 2 is a plan view of an assembly 120 including a first crank arm 100A and a second crank arm 100B. In the embodiment of FIG. 2, each crank arm has a generally curved resting shape defining a convex arch 106 and a concave arch 108. In the embodiment of FIG. 2, the fulcrum end of each crank arm is attached to a hub 122. Each crank arm is oriented so that a concave arch of the crank arm is directed upwardly during an upward stroke 124 and so that the concave arch of each crank arm is directed downwardly during a downward stroke 126. In the embodiment of FIG. 2, first crank arm 100A is disposed in downward stroke 126, and second crank arm 100B is disposed in upward stroke 124.

A first pedal 128A is pivotally coupled to first crank arm 100A proximate the free end thereof. Likewise, a second pedal 128B is pivotally coupled to second crank arm 100B proximate the free end thereof. Embodiments of the present invention are possible in which a toe clip is attached to each pedal. Examples of toe clips which may be suitable for use in conjunction with the present invention include those disclosed in U.S. Pat. Nos. 4,033,199, 4,269,084, 4,682,514, 4,787,266, and 4,870,873. The entire disclosure of each of the U.S. patents mentioned above is hereby incorporated by reference in its entirety. It is important to note that a human bicycle rider's legs create a larger force on the downward stroke than they do on the upstroke. In other words there is a force differential between the force provided by a human leg during the downward stroke and the force provided by a human leg during the upstroke.

Applicant has found that bicycle cranks in accordance with the present invention provide for more pleasant pedaling. Applicant has fabricated a first crank arm and a second crank arm in accordance with the present invention and installed these arms on a bicycle. Applicant rode this bicycle on a daily basis over a period of months including going up hills. Additionally, applicant invited two other persons to ride this bicycle. These other persons reported that the bicycle provided a more leisurely and pleasant feeling to pedaling instead a feeling of hard work. Crank arms in accordance with the present invention provide a feeling as though the bike is working for the rider. Bicycle cranks in accordance with the present invention provide a better interface during the upstroke portion of pedaling. Without wishing to be bound to any particular theory, it appears that crank arms in accordance with some embodiments of the present invention provide a feeling that the work is being more evenly divided between the rider's two legs.

In some embodiments of the present invention, each crank arm provides a first, larger mechanical advantage during upward stroke 124 and a second, smaller mechanical advantage during downward stroke 126. In some advantageous embodiments, the difference between the first mechanical advantage and the second mechanical advantage is selected to compensate for a difference in strength between the downward pushing muscles of a human leg and the upward pulling muscles of the human leg. A larger mechanical advantage may be provided when, for example, each crank arm assumes an elongated shape during upward stroke 124. Embodiments of the present invention are possible in which a toe clip is fixed to each pedal 128. When this is the case, an upward force 134 may be applied to each pedal 128 during each upward stroke 124. In some of these embodiments, each crank arm may assume an elongated shape upon the application of upward force 134. A smaller mechanical advantage may be provided, for example, when the crank arm assumes a foreshortened shape upon application of a downward force 136. A crank arm in accordance with the present invention may be made sufficiently resilient to assume the elongated shape and the foreshortened shape by selecting an appropriate combination of material characteristics (e.g., modulus of elasticity) and material dimensions (e.g., material thickness).

In some embodiments of the present invention, each crank arm applies a first moment to hub 122 while upward force 134 is applied proximate the free end of the crank arm and each crank arm applies a second moment to hub 122 while downward force 136 is applied proximate the free end of the crank arm during downward stroke 126. In some of these embodiments, the first moment is substantially equal to the second moment while downward force 136 has a greater magnitude than upward force 134. In some cases, downward force 136 is greater than upward force 134 by a force differential. In some cases, the force differential is substantially equal to the difference in strength between the downward pushing muscles of a human leg and the upward pulling muscles of the human leg.

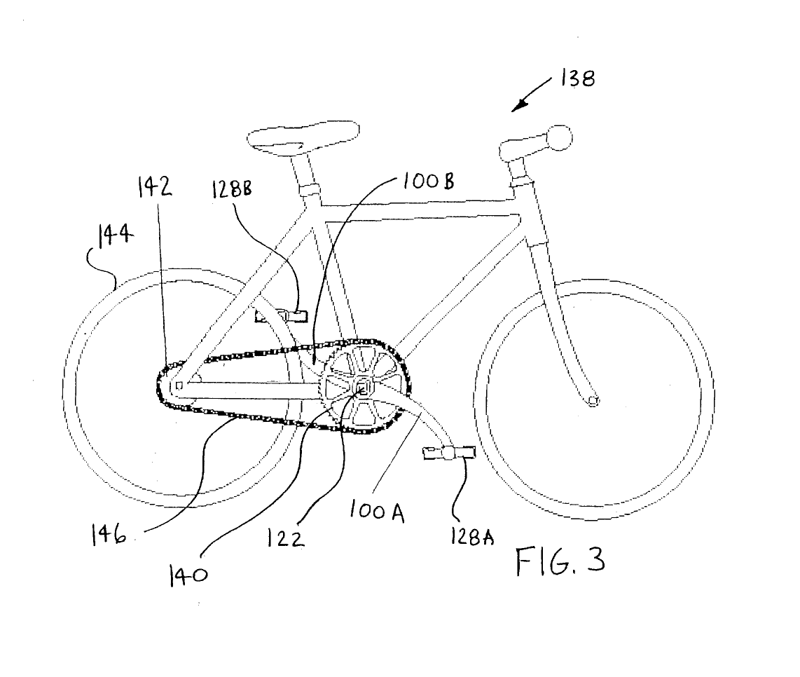

FIG. 3 is a plan view of a bicycle 138 in accordance with an exemplary embodiment of the present invention. Bicycle 138 includes a first crank arm 100A having a fulcrum end coupled to a hub 122. Bicycle 138 also includes a second crank arm 100B having a fulcrum end coupled to hub 122. In the embodiment of FIG. 3, a first sprocket 140 is shown fixed to hub 122. Also in the embodiment of FIG. 3, a second sprocket 142 is shown fixed to a rear wheel 144 of bicycle 138. In FIG. 3 is may be appreciated that first sprocket 140 and second sprocket 142 are coupled by an endless drive chain 146. A first pedal 128A is pivotally coupled to first crank arm 100A proximate the free end thereof. Likewise, a second pedal 128B is pivotally coupled to second crank arm 100B proximate the free end thereof.

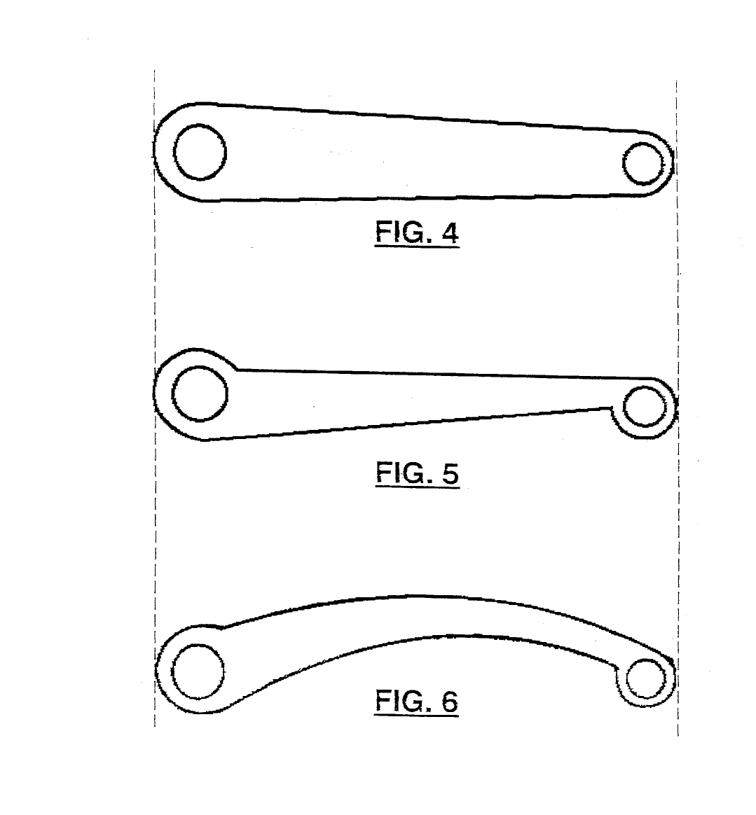

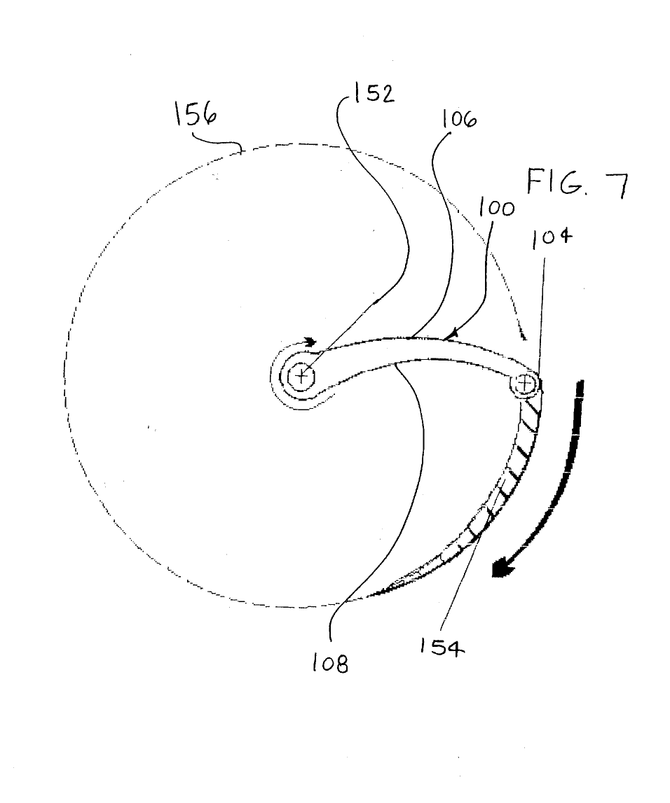

FIG. 4 is a plan view of a straight crank arm. FIG. 5 is a plan view of another crank arm. FIG. 6 is a plan view of an arched crank arm. FIG. 7 diagrams the rotation and the torque of the arched bicycle crank arm. As shown in FIG. 7, the arched bicycle crank arm 100 is designed to generate the strongest centripetal force 154 when rotated in one direction only. The arm is positioned with the concave arch 108 on the bottom and convex arch 106 on top. When the fulcrum point 152 is centered and the free end 104 of the arm is to the right, maximum power is generated when the lever is rotated clockwise. When the free end 104 of the arm is to the left, maximum power is generated when the lever is rotated counter-clockwise, and a conventional straight crank arm's circle 156 is as same as a free end's circle of the arched bicycle crank arm 100 with the strongest centripetal force 154.

Numerous characteristics and advantages of the invention covered by this document have been set forth in the foregoing description. It will be understood, however, that this disclosure is, in many respects, only illustrative. Changes may be made in details, particularly in matters of shape, size and ordering of steps without exceeding the scope of the invention. The invention's scope is, of course, defined in the language in which the appended claims are expressed.

What is claimed is:

1. An assembly, comprising:
a first crank arm having a fulcrum end and a free end;
a second crank arm having a fulcrum end and a free end;
the fulcrum end of each crank arm being attached to a hub;
each crank arm having a generally curved shape defining a convex arch and a concave arch;
each crank arm being oriented so that the concave arch of the crank arm is directed upwardly during an upward stroke and downwardly during a downward stroke; and
each crank arm providing a first, larger mechanical advantage during the upward stroke and a second, smaller mechanical advantage during the downward stroke.

2. An assembly, comprising:
a first crank arm having a fulcrum end and a free end;
a second crank arm having a fulcrum end and a free end;
the fulcrum end of each crank arm being attached to a hub;
each crank arm having a generally curved shape defining a convex arch and a concave arch;
each crank arm being oriented so that the concave arch of the crank arm is directed upwardly during an upward stroke and downwardly during a downward stroke;
each crank arm applying a first moment to the hub while an upward force is applied proximate the free end of the crank arm during the upward stroke and each crank arm applying a second moment to the hub while a downward force is applied proximate the free end of the crank arm during the downward stroke, the first moment being substantially equal to the second moment while the downward force is greater than the upward force.
